(19) United States
(12) Patent Application Publication
(10) Pub. No.: US 2007/0102965 A1
(43) Pub. Date: May 10, 2007

(54) Hydroformed windshield surround frame for vehicles and method of making same

(76) Inventors: Sanjay M. Shah, Troy, MI (US); Daniel L. Sobey, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/266,951

(22) Filed: Nov. 4, 2005

(51) Int. Cl. B60J 7/00

(52) U.S. Cl. 296/201

(57) ABSTRACT

A hydroformed windshield surround frame for a vehicle and method of making same includes a top portion extending laterally, a pair of opposed pillar portions extending generally perpendicular from the top portion, and a pair of corner portions interconnecting the top portion and the pillar portions. The top portion, the pillar portions, and the corner portions form a monolithic structure being integral, unitary, and one-piece.

### TECHNICAL FIELD

The present invention relates generally to vehicles and, more particularly, to a hydroformed windshield surround frame for a vehicle and method of making same.

### BACKGROUND OF THE INVENTION

It is known to provide a windshield for a vehicle such as an automotive vehicle. Typically, the windshield is mounted to a vehicle body of the vehicle by a frame. This frame is commonly called a “windshield surround frame” (WSF). Typically, the WSF is constructed out of multiple stamped pieces.

It is also known to hydroform tubular components or members. Hydroformed tubular members are becoming increasingly popular in automotive body structural applications. During vehicle body manufacturing, many of the hydroformed tubular members are used in vehicle body and chassis applications. However, in one known application for a vehicle, the WSF is made out of multiple hydroformed pieces welded together.

As a result, it is desirable to provide a new windshield surround frame for a vehicle that reduces overall cost in part fabrication and assembly. It is also desirable to provide a new windshield surround frame for a vehicle that provides better product performance (stiffness) and better quality (dimensional performance). It is further desirable to provide a new method of making a hydroformed windshield surround frame for a vehicle that eliminates multiple parts or welding. Therefore, there is a need in the art to provide a new windshield surround frame and method of making same that meets these desires.

### SUMMARY OF THE INVENTION

Accordingly, the present invention is a hydroformed windshield surround frame for a vehicle including a top portion extending laterally, a pair of opposed pillar portions extending generally perpendicular from the top portion, and a pair of corner portions interconnecting the top portion and the pillar portions. The top portion, the pillar portions, and the corner portions form a monolithic structure being integral, unitary, and one-piece.

Also, the present invention is a method of making a hydroformed windshield surround frame for a vehicle. The method includes the steps of providing a tubular member and bending the tubular member to form a bent tubular member. The method also includes the steps of hydroforming the bent tubular member into a windshield surround frame having a monolithic structure being integral, unitary, and one-piece.

One advantage of the present invention is that a hydroformed windshield surround frame is provided for a vehicle, which eliminates multiple pieces of traditional stamped parts. Another advantage of the present invention is that a method of making a hydroformed windshield surround frame is provided for a vehicle, which eliminates multiple hydroformed pieces welded together. Yet another advantage of the present invention is that the hydroformed windshield surround frame and method reduces part fabrication cost and assembly cost. Still another advantage of the present invention is that the hydroformed windshield surround frame and method provides improved product performance (stiffness) and quality (dimensional performance).

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a vehicle incorporating a hydroformed windshield surround frame, according to the present invention.

FIG. 2 is a perspective view of the hydroformed windshield surround frame and a windshield frame assembly of FIG. 1.

FIG. 3 is an exploded perspective view of the hydroformed windshield surround frame and windshield frame assembly of FIG. 2.

### DESCRIPTION OF THE PREFERRED EMBODIMENT

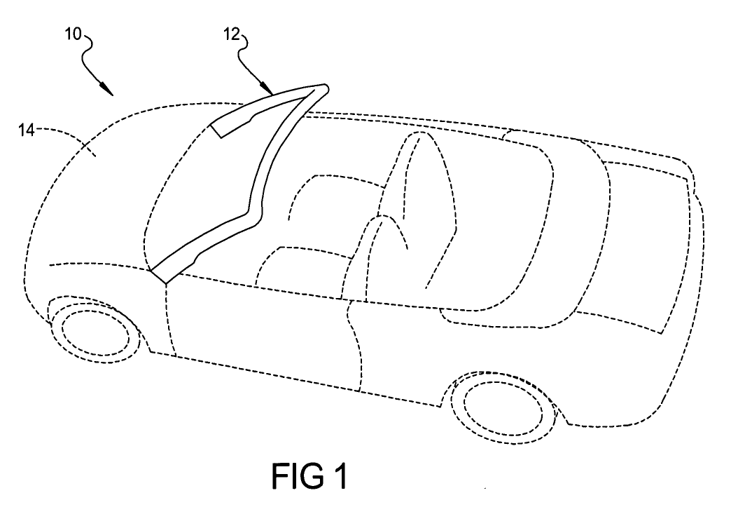

Referring to the drawings and in particular FIG. 1, a vehicle 10 is shown incorporating one embodiment of a windshield frame assembly 12, according to the present invention. The vehicle 10 includes a vehicle body 14 supported by surrounding structural members (not shown). The windshield frame assembly 12 is attached to and supported by the vehicle body 14. It should be appreciated that, except for the windshield frame assembly 12, the vehicle 10 is conventional and known in the art.

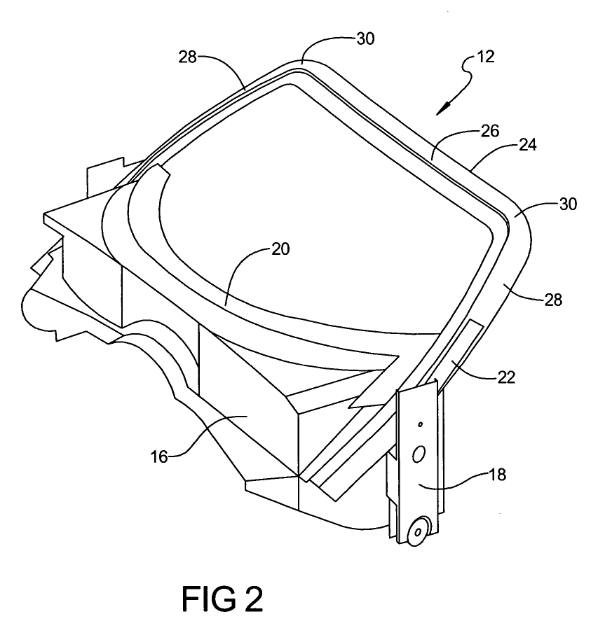

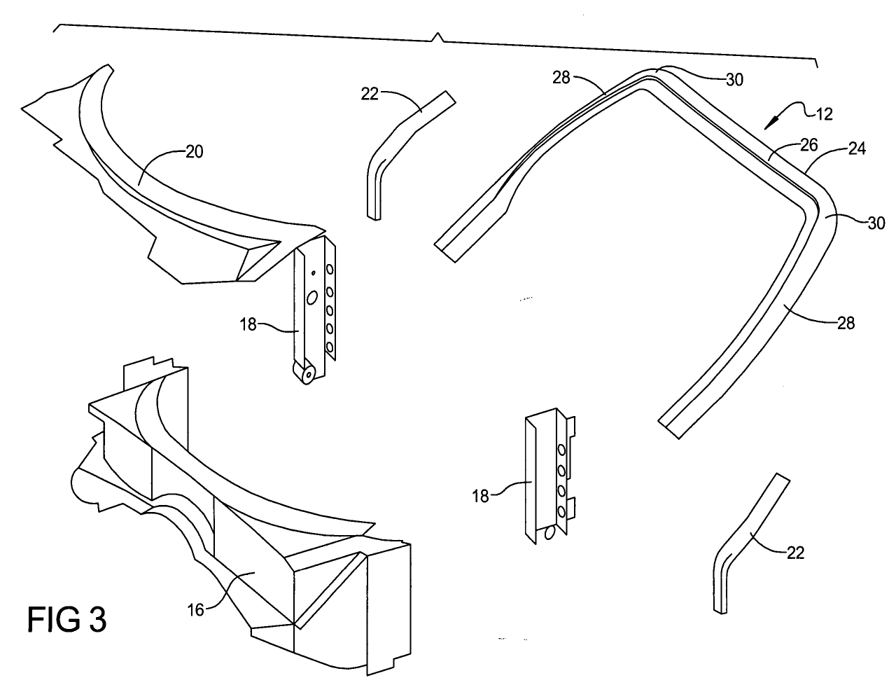

Referring to FIGS. 2 and 3, the windshield frame assembly 12 includes a base support member 16 extending laterally. The windshield frame assembly 12 also includes at least one, preferably a pair of side members 18 with one side member 18 attached to each of the sides of the base support member 16. In one embodiment, the side members 18 extend generally vertically and have a generally “C” cross-sectional shape. The windshield frame assembly 12 includes an upper support member 20 extending laterally and disposed between the side members 18. The windshield frame assembly 12 includes at least one, preferably a pair of arm members 22 with one arm member 22 attached to each of the side members 18. In one embodiment, the arm members 22 are each generally “L” shaped and have a generally tubular cross-sectional shape. The windshield frame assembly 12 further includes a hydroformed windshield surround frame 24, according to the present invention, attached to the upper support member 20 and to each of the arm members 22.

In one embodiment, the hydroformed windshield surround frame 24 is a tubular member having a generally inverted “U” shape. The hydroformed windshield surround frame 24 has a top portion 26 extending laterally and a pillar portion 28 extending generally perpendicular from each end of the top portion 26. The hydroformed windshield surround frame 24 also has a corner portion 30 between the top portion 26 and each pillar portion 28. The corner portion 30 is generally curved or arcuate in shape. The hydroformed windshield surround frame 24 has different cross-sectional shapes such as rectangular, oval, or multi-faceted along the top portion 26, pillar portion 28, and corner portion 30. The hydroformed windshield surround frame 24 is made of a metal material such as steel, stainless steel, or aluminum and formed by a hydroforming process. The hydroformed windshield surround frame 24 is a monolithic structure being integral, unitary, and one-piece. It should be appreciated that, in certain applications, stainless steel is used for the hydroformed windshield surround frame 24 in order to achieve higher strength along with adequate ductility (for tight bends). It should also be appreciated that the hydroforming process is used in order to achieve different cross-sectional shapes. It should further be appreciated that the different cross-sectional shapes of the hydroformed windshield surround frame 24 provides both structural load path (for stiffness, etc.) and mounting areas for surrounding members (e.g., windshield, brackets, etc.).

For assembly of the windshield frame assembly 12, the upper support member 20 is disposed between the pillar portions 28 of the hydroformed windshield surround frame 24. The upper support member 20 is welded and joined to the hydroformed windshield surround frame 24. The hydroformed windshield surround frame 24 is disposed between the two arm members 22. The windshield surround frame 24 is welded and joined to the arm members 22. The arm members 22 are disposed inside of the side members 18 and the base support member 16 is disposed between the side members 18. The side members 26 are welded and joined to the base support member 16 and the arm members 22 are welded and joined to the side members 26. It should be appreciated that conventional joining techniques such as spot welding, brazing, adhesives, laser, fasteners, etc., can be used to integrate the hydroformed windshield surround frame 24 with the rest of the windshield frame assembly 12.

One embodiment of a method, according to the present invention, of making a hydroformed windshield surround frame 24 is disclosed. The method includes the step of providing a tubular member or blank (not shown). The tubular member has either a circular or non-circular cross-sectional shape. The method includes the step of bending the tubular member into a bent tubular member. In order to create tight bend corners, hydro-bending can be used. In this method, general shape bends are created using a rotary draw bender (not shown) to form the bent tubular member. For example, larger cross-sectional corner radii in selected bend areas allow for tighter bends. It should be appreciated that this method is suggested only when tight corner bend radii are required.

According to one method of hydroforming, the bent tubular member is placed in a die set (not shown) comprised of an upper die half and a lower die half. The ends of the bent tubular member are sealed and hydraulic fluid is pumped into the bent tubular member under pressure. The upper die half and lower die half are progressively closed so that the bent tubular member is progressively deformed and the pressurized fluid captured therein expands the walls of the bent tubular member into cavity portions of the die halves. It should be appreciated that, when the bent tubular member is placed in the hydroform die, further bending near the corners is achieved during the closing with fluid pressure inside the bent tubular member.

Once the die is closed, the bent tubular member is then expanded to a final cross-sectional profile by increasing the hydraulic pressure sufficient to exceed the yield limit of the bent tubular member so that the bent tubular member is forced into conformity with the cavity portions of the die halves. The die halves are then opened to permit removal of the finished hydroformed windshield surround frame 24 from the die halves. It should be appreciated that other methods of hydroforming may involve substitution of pre-forming for the initial pressure stage.

The method also includes the step of providing a base support member 16, side members 18, upper support member 20, and arm members 22 and joining the base support member 16, side members 18, upper support member 20, arm members 22, and hydroformed windshield surround frame together. The method includes the step of welding the upper support member 20 and hydroformed windshield surround frame 24 together. The method further includes the step of welding the arm members 22 and the hydroformed windshield surround frame 24 together. The method includes the step of welding the arm members 22 and the side members 18 together. The method further includes the step of welding the base support member 16 and the side members 18 together to form the windshield frame assembly 12. It should be appreciated that the welds may be spot, laser, and/or continuous.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A hydroformed windshield surround frame for a vehicle comprising:
a top portion extending laterally;
a pair of opposed pillar portions extending generally perpendicular from said top portion;
a pair of corner portions interconnecting said top portion and said pillar portions; and
wherein said top portion, said pillar portions, and said corner portions form a monolithic structure being integral, unitary, and one-piece.

2. A hydroformed windshield surround frame as set forth in claim 1 wherein said top portion, said pillar portions, and said corner portions have different cross-sectional shapes.

3. A hydroformed windshield surround frame as set forth in claim 1 wherein said top portion, said pillar portions, and said corner portions are made of a metal material.

4. A hydroformed windshield surround frame as set forth in claim 1 wherein said top portion, said pillar portions, and said corner portions are made of stainless steel.

5. A windshield frame assembly for a vehicle comprising:
a pair of side members;
a base support member disposed between and joined to said side members;
a pair of arm members joined to said side members; and
a hydroformed windshield surround frame disposed between and joined to said arm members, said hydroformed windshield surround frame being a monolithic structure being integral, unitary, and one-piece.

6. A windshield frame assembly as set forth in claim 5 wherein said hydroformed windshield surround frame has a generally inverted “U” shape.

7. A windshield frame assembly as set forth in claim 5 wherein said hydroformed windshield surround frame has different cross-sectional shapes along a length thereof.

8. A windshield frame assembly as set forth in claim 5 wherein said hydroformed windshield surround frame comprises a top portion extending laterally, a pair of opposed pillar portions extending generally perpendicular from said top portion, and a pair of corner portions interconnecting said top portion and said pillar portions.

9. A windshield frame assembly as set forth in claim 5 wherein said hydroformed windshield surround frame is made of a metal material.

10. A windshield frame assembly as set forth in claim 5 wherein said hydroformed windshield surround frame is made of stainless steel.

11. A windshield frame assembly as set forth in claim 5 including at least one weld to join said hydroformed windshield surround frame to either one of said arm members and said top support member.

12. A windshield frame assembly as set forth in claim 11 wherein said at least one weld comprises a plurality of welds to join said hydroformed windshield surround frame to either one of said arm members and said top support member.

13. A method of making a hydroformed windshield surround frame for a vehicle, said method comprising the steps of:
providing a tubular member;
bending the tubular member to form a bent tubular member; and
hydroforming the bent tubular member into a windshield surround frame having a monolithic structure being integral, unitary, and one-piece.

14. A method as set forth in claim 13 wherein said step of hydroforming comprises hydroforming the tubular member into a hydroformed windshield surround frame having a generally inverted “U” shape.

15. A method as set forth in claim 13 wherein said step of hydroforming comprises hydroforming the tubular member into a hydroformed windshield surround frame having a top portion extending laterally, a pair of opposed pillar portions extending generally perpendicular from the top portion, and a pair of corner portions interconnecting the top portion and the pillar portions.

16. A method of making a windshield frame assembly for a vehicle, said method comprising the steps of:
providing a base support member;
providing a pair of side members;
providing a pair of arm members; and
providing a hydroformed windshield surround frame;
disposing the hydroformed windshield surround frame between the arm members;
disposing the arm members adjacent the side members;
disposing the base support member between the side members; and
joining the hydroformed windshield surround frame, arm members, side members, and base support member together.

17. A method as set forth in claim 16 wherein said step of providing a hydroformed windshield surround frame comprises hydroforming a windshield surround frame with a generally inverted “U” shape.

18. A method as set forth in claim 16 wherein said step of providing a hydroformed windshield surround frame comprises hydroforming a windshield surround frame with a top portion extending laterally, a pair of opposed pillar portions extending generally perpendicular from the top portion, and a pair of corner portions interconnecting the top portion and the pillar portions.

19. A method as set forth in claim 16 wherein said step providing a hydroformed windshield surround frame comprises hydroforming a windshield surround frame as a monolithic structure being integral, unitary, and one-piece.

20. A method as set forth in claim 16 wherein said step providing a hydroformed windshield surround frame comprises hydroforming a windshield surround frame having different cross-sectional shapes along a length thereof.
